(19) United States
(12) Patent Application Publication
(10) Pub. No.: US 2005/0149549 A1
(43) Pub. Date: Jul. 7, 2005

(54) Content management in web environments

(76) Inventors: Jos Jaspers, Nijmegen (NL); Fred Keultjes, Duiven (NL)

Correspondence Address: FISH & RICHARDSON P.C., 1425 K STREET, N.W., 11TH FLOOR, WASHINGTON, DC, 20005-3500, US

(21) Appl. No.: 10/749,421

(22) Filed: Dec. 31, 2003

(51) Int. Cl. G06F 17/00

(52) U.S. Cl. 707/102

(57) ABSTRACT

Techniques for generating portions of a web environment provide for an automated or semi-automated generation of a web site. A user interface adapted to allow a user to configure parameters relating to a set of predefined components for a web environment is presented. Data defining the parameters for the web environment is received. At least a portion of the web environment is automatically generated based on the received data, and the generated web environment includes components specified by the parameters.

### TECHNICAL FIELD

This description relates to web environments, and more particularly, to content management in web environments.

### BACKGROUND

A user may desire to publish information, commonly referred to as “content,” in an electronic format, such as HyperText Markup Language (HTML), such that the content is readily available to others. To do so, a user may electronically publish the content on a web site or web page that is accessible through the Internet, the World Wide Web, a local area network (“LAN”), a wide area network (“WAN”), an extranet, or an intranet.

Conventional techniques for content management include providing a user with tools to add and/or manipulate content in an HTML-based environment. These tools may include HTML editors that allow a user to assemble or modify aspects of the layout and presentation of content in an HTML-based environment. Additionally, conventional techniques for content management require content to be provided by an entity that generates the content to a centralized publishing entity that places or modifies the content on a website with specialized tools.

### SUMMARY

Techniques are provided for content management and generating portions of a web environment. In one general aspect, a user interface may be presented to a user. The user interface may be adapted to allow the user to configure parameters relating to a set of predefined components for a web environment. Data defining the parameters for the web environment may be received. At least a portion of the web environment may be automatically generated based on the received data, and the generated web environment includes components specified by the parameters.

Particular implementations may include one or more of the following features. For example, the presented user interface may be a form adapted to allow a user to configure the parameters. The form may include entry fields, and each entry field may correspond to one of the predefined components. The generated web environment may be based on a template defining a presentation format for the generated web environment. The parameters may include data defining content for the generated web environment.

The generated web environment may include web pages. A request to publish content in one or more of the web pages may be received, and, in response to the request to publish content, a content definition user interface may be presented. The content definition user interface may be adapted to receive an identification of content, and the identified content may be published in accordance with a predefined presentation format. Data corresponding to a request to navigate to a particular location within the web environment may be received, and the request to publish content may be received in connection with a display of the particular location on a user interface. The identified content may be published at the particular location. The particular location may be a folder within a folder hierarchy displayed on the user interface, and the folder hierarchy may correspond to a logical structure of the web environment.

The set of predefined components may be a library of components that can be enabled, disabled, and customized, and the predefined components may be web page components. Each web page component may define a presentation format for data on a web page. A request to publish content in one or more of the web page components may be received. In response to the request to publish content, a content definition user interface adapted to receive an identification of content may be presented, and the identified content may be published in accordance with a predefined presentation format. The content may include one or more links to a web page. A request to modify a logical structure of the web environment may be received. The logical structure of the web environment may be modified in accordance with the request to modify the logical structure, and the one or more links may be updated in accordance with the modified logical structure.

The details of one or more implementations are set forth in the accompanying drawings and the description below. Other features will be apparent from the description and drawings, and from the claims.

### DESCRIPTION OF DRAWINGS

FIG. 1 is a block diagram of a system for maintaining, generating, and accessing a web environment.

FIG. 2A is an example of a new site request form.

FIG. 2B is an example of a homepage for a site that corresponds to the new site request form of FIG. 2A.

FIG. 3 is an illustrative example of a page for managing web-based content.

FIG. 4 is an illustrative example of a form for creating new content.

FIG. 5 is a block diagram showing a logical structure for a web environment.

FIG. 6 is a flow diagram of a process for generating a web environment.

Like reference symbols in the various drawings indicate like elements.

### DETAILED DESCRIPTION

Techniques for content management simplify the process of publishing electronic content. Techniques for content management may include presenting a user interface that allows a user who wants to electronically publish content to configure parameters relating to a predefined set of components for a web environment. The parameters may define which components are used, while the layout and appearance of the components, individually and collectively, may be defined by a predefined template. Data defining the parameters for the web environment is received, and at least a portion of the web environment may automatically be generated based on the received data. The generated web environment may have components configured according to the parameters.

When an individual or an enterprise desires to create a new web environment (i.e., a web site), a site administrator accesses a new site request form and completes the new site request form. The new site request form corresponds to a template that defines the layout and appearance of a generic site. The new site request form may be a checklist that allows the site administrator to specify components from a library of available, predefined components for the generic site that are to be included in the new site. Accordingly, the new site request form includes a number of items that can be selectively enabled or disabled by the site administrator. Each item corresponds to an available component for the generic site. To simplify the process of producing new sites and/or to maintain consistency across multiple different sites within an enterprise, the new site may be generated primarily or exclusively from predefined components.

At the same time, however, the new site request form may allow the site administrator to customize the content of the available components according to the desired function and content of the new site. Accordingly, the new site request form prompts the site administrator to enter text or other data in predetermined data fields to be displayed on the new site. Implementations may include different templates depending on the type of site to be produced. For example, different templates may be available for country sites (i.e., sites associated with a particular country), organizational sites (i.e., sites associated with an organizational structure, such as human resources, marketing, or research and development, within an enterprise), intranet sites, extranet sites, and Internet sites. Each type of site may have a different presentation format. Alternatively, different templates may be selected depending on the information that the site administrator provides on the new site request form. Certain components may be required for particular types of sites and/or for all sites in the enterprise.

The predefined textual components of a generic site may be defined in any number of different languages (e.g., English, Dutch, German, French, etc.). Accordingly, users of the new site may be able to selectively switch among different languages. The generic portions of the new site that are predefined by the components can therefore be displayed in any of the available languages without additional effort by the site administrator. The content of the new site (e.g., web pages and documents), on the other hand, may be displayed only in the language or languages in which site administrator or other content publishers enter the content, although the site administrator or other content publishers may enter the content in multiple languages to create a more fully multilingual site.

Once the site administrator completes the new site request form, the new site is generated in accordance with the information provided on the new site request form. For example, the components that the new site request form indicates are to be enabled are included in the new site according to a presentation format defined by the corresponding template, and the components that the new site request form indicates are to be disabled are not included in the new site. The new site may be generated in a fully or partially automated process. Generating and installing the new site may also involve some manual activities.

The new site or a larger web environment that contains the new site may also include a mechanism for allowing the site administrator to grant permissions for content publishers to publish content on the new site. In general, the new site that is generated may be a top-level web page or a collection of top-level web pages that are controlled by the site administrator. Content publishers may be permitted to publish additional content that is included within components of the top-level page or collection of top-level web pages and/or that is included in one or more web pages within the new site. For example, the top-level web page may include a link to another web page that contains the additional content. By default, web pages that are added by content publishers may include some of the same basic components as the top-level web page, such as the site name, links to other sites and/or web pages, a search component, a calendar, a component for switching languages, and advertisements.

As with the generation of the new site, new content may be generated using tools that enable content publishers to select among a library of different generic content components, such as web pages, attachments, layout options, events, and links. After selecting a generic content component, content publishers then insert text, documents, or other information, which is the actual content. Accordingly, the tools allow content publishers to add content according to predefined presentation formats so that the content publishers do not need knowledge of HTML or other specialized languages or specialized formatting techniques. Furthermore, the content publishers can navigate to the location within the new site where the added content is to be published. This navigation can be accomplished by navigating through links in the new site to a web page (or a parent web page) where the content is to be published. Alternatively, navigation may involve navigating a folder hierarchy that corresponds to the logical structure of the new site. The folder hierarchy may include, for example, a top-level folder that corresponds to the top-level web page for the new site, sub-folders corresponding to major web pages within the new site, and sub-sub-folders that are subordinate to the major web pages. As a result, the content publishers do not need to know the navigational structure of the site or perform coding of relationships among the web pages to be published.

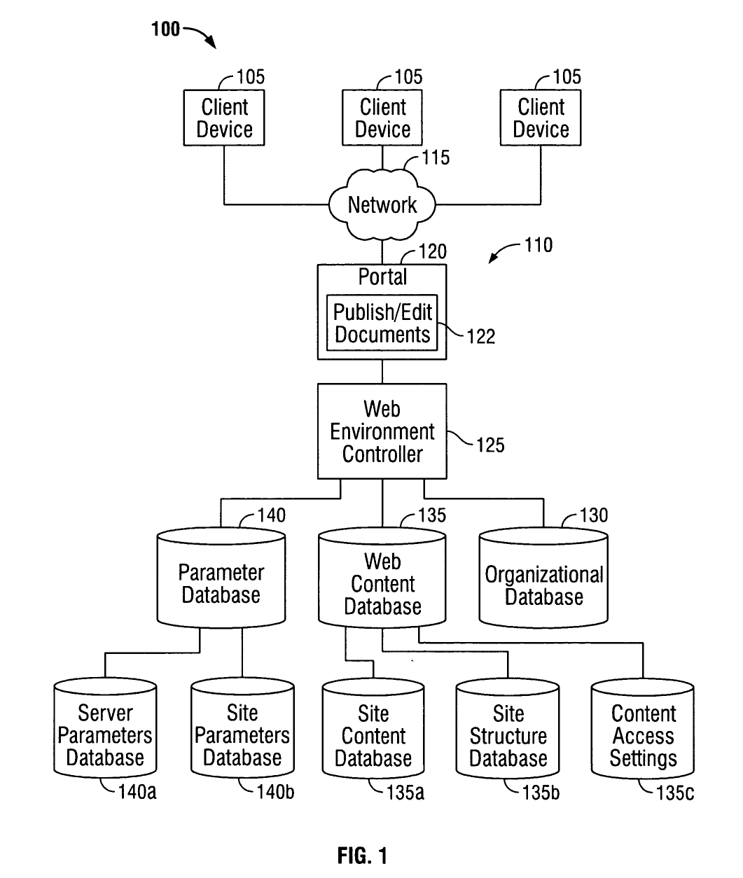

FIG. 1 is a block diagram of a system 100 for maintaining, generating, and accessing a web environment. The system 100 includes client devices 105 that connect to a server 110 through a network 115, such as a LAN, WAN, or the Internet. The client devices display user interfaces for interacting with the functionalities of the server 110. The server 110 supports a web environment that includes one or more web sites for an enterprise and that includes applications for generating and controlling the web sites. The server 110 includes a portal 120 through which web sites, applications, and data within the web environment can be accessed. The portal 120 provides access for users to publish and edit web documents (as indicated at 122). The server 110 also includes a web environment controller 125 that includes applications for generating web sites and controlling access to the web sites and to tools for generating, modifying, and adding content to the web sites.

The web environment controller 125 performs access control functions using data stored in an organizational database 130. For example, the web environment controller 125 may require users to supply login information, such as a user name and password, or access control may be synchronized with a network login, such as that provided by a Windows network login. Users may have different levels of access permissions based on the roles associated with the user. The roles may be defined in the organizational database 130. Accordingly, access to functionalities may be based on roles associated with the users rather than the user's particular identity. Roles may include site administrator, content publisher, and visitors. Users may take on different roles at different times and/or for different parts of the web environment. For example, a particular user may be associated with a site administrator role for a specific site and may be associated with a visitor role for other sites. The same user may also be associated with a content publisher role and a visitor role with respect to the specific site. Accordingly, the user may act as a site administrator for the specific site at one time, a content publisher on the specific site at another time, and a visitor at some other time depending on the functionalities the user wants to access. The different roles held by a user may require separate logins or may be concurrently available to the user, so that the user does not have to log off and log back in to act in a different role.

Each site within the web environment has an associated site administrator role. One or more users may be associated with the site administrator role. A site administrator for a particular site may control and define the permissions granted to content publishers and visitors for the particular site. The organizational database 130 may store information regarding predefined user groups. The site administrator can access the user group information to assign the role of content publisher to one or more selected user groups. In addition, the site administrator may be able to define new user groups and modify user groups by adding or deleting individual users in the user groups. The site administrator may also be able to control visitor access to the web site and/or to web pages and other content within the web site based on roles. For example, some content may be accessible to all users while other content may be accessible only to members of certain user groups.

As discussed above, the site may be organized as a folder hierarchy. For purposes of assigning content publisher roles, the site administrator may assign one particular folder or group of folders (or web pages) to a first user group and another folder or group of folders to a second user group. Content publishing access rights to existing sub-folders may not be automatically inherited. In other words, a user group in the role of content publisher for a particular folder may not have permission to modify or add content to existing sub-folders. In some cases, however, the content publisher for a particular folder may be able to add new sub-folders that automatically inherit the permissions and other settings for the parent folder, although the site administrator may subsequently change the access right permissions.

In addition to controlling access based on user roles, the content that is displayed on the portal or in individual web pages may differ depending on the user group or groups associated with the user. For example, a user in a human resources user group may be presented with different content on the portal than a user in a sales group. News items that may be of interest to people in human resources may be displayed for the human resources users, while different new items may be displayed for sales force members.

The server 110 also includes a web content database 135 and a parameter database 140. The parameter database 140 stores the templates that define the generic sites and the generic components. The web content database 135 defines the hierarchy of the web pages, the content of these web pages, and the access settings on a folder level for each site within the web environment. On a folder level, the web content database 135 specifies which organization member can view or edit pages and which pages are published as news in the portal 120. For example, the hierarchy may be defined using a folder hierarchy. The parameters database 140 stores an identification of the specific combination of components that are enabled and disabled for each site. In addition, the parameters database 140 stores the content for each site. Alternatively, the content may be stored in another database accessible by the web environment controller 125, through the portal 120, or through the network 115. The web environment controller 125 assembles the sites and the web pages by combining the data stored in the web structure database 135, the parameter database 140, and the organizational database 130.

In some implementations, the parameter database 140 and the web content database 135 may be broken down into multiple databases containing more specific types of data. The parameter database 140 may include a server parameters database 140a and a site parameters database 140b. The server paramaters database 140a may store parameters that are shared across sites and/or web pages in the web environment that is supported by the server 110. The site parameters database 140b may store parameters that are specific to individual sites and/or web pages. The web content database 135 may include a site content database 135a, a site structure database 135b, and a content access settings database 135c. The site content database 135a may store actual content (e.g., web documents) to be published on the portal 120 and in individual web pages, and/or pointers to other locations where actual content to be published is stored. The site structure database 135b may store data defining the hierarchy of web pages (i.e., a folder hierarchy). The content access settings database 135c may store data defining which user groups have visitor, content publisher, and site administrator access rights on a folder or web page level for each site within the web environment.

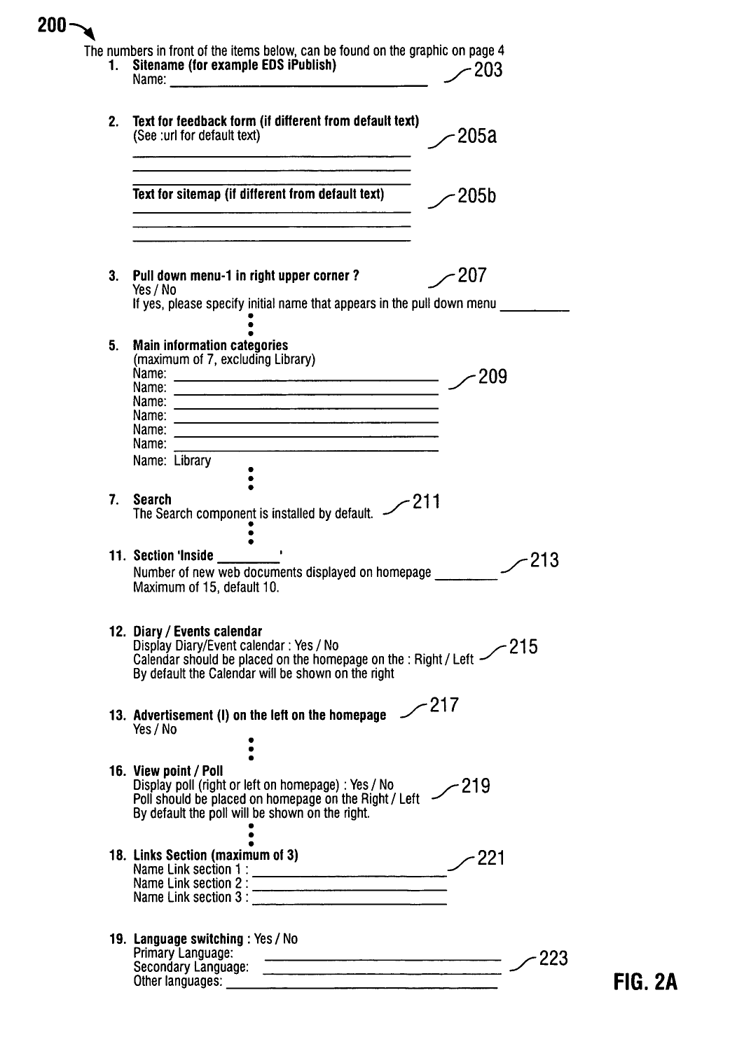

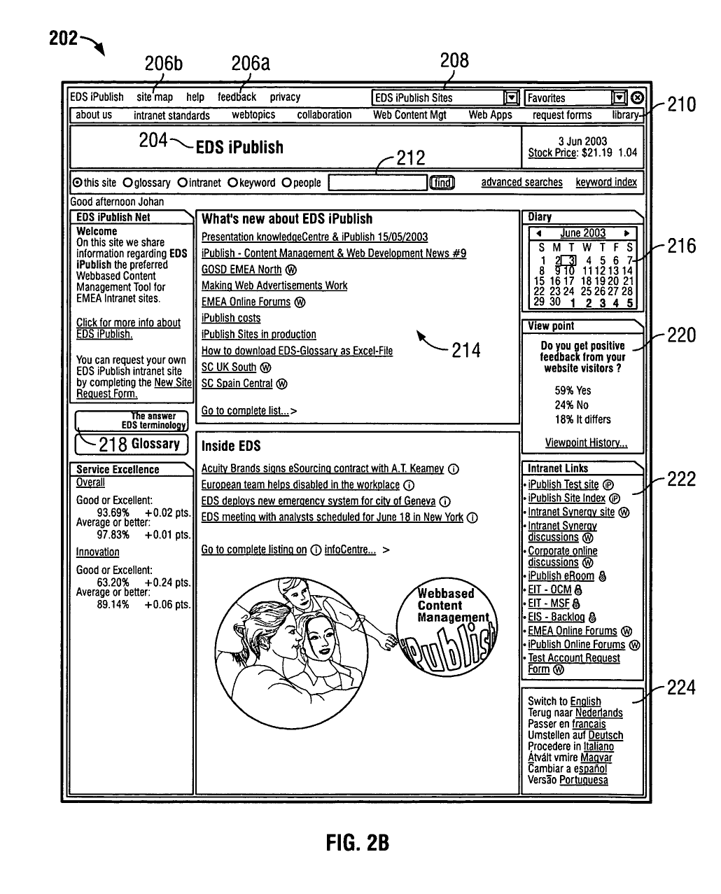

FIG. 2A is an example of a new site request form 200, and FIG. 2B is an example of a homepage 202 for a site that corresponds to the new site request form 200. The new site request form 200 is a checklist for creating a new site and includes a number of data entry fields for selecting which components are to be included in the new site. The data entry fields of the new site request form 200 include some entries that prompt a user to enable or disable certain components. Some entries correspond to mandatory components and prompt the user to enter textual content to be included in the component. The homepage 202 includes components that correspond to each of the entries in the new site request form 200 after completion of the new site request form 200 and after the site is generated. Although the homepage 202 includes all of the available components (i.e., all of the available components are enabled), implementations may include only some of the available components depending on the selections made by the user. Each component has a predefined presentation format and location within the homepage 202.

The new site request form 200 includes a sitename entry 203, which prompts the user to define a name for the site. The homepage 202 includes a corresponding sitename component 204. A feedback form entry 205a and a sitemap form entry 205b correspond to a feedback component 206a and a sitemap component 206b. A pull-down menu entry 207 allows the user to select whether a pull-down menu is displayed on the homepage 202 and corresponds to a pull-down menu component 208. A main information categories entry 209 allows the user to enter desired information categories (e.g., about us, collaboration, etc.) and corresponds to a main information category component 210. A search entry 211 corresponds to a search component 212, which is mandatory in this example. A current information entry 213 corresponds to a web document links component 214 that provides an area for links to web documents on the homepage 202.

A calendar entry 215 allows the user to select whether to include, and a location for, a calendar component 216. An advertisement entry 217 allows the user to select whether to include an advertisement component 218. A poll entry 219 allows the user to select whether to include, and a location for, an online poll component 220. A links section entry 221 allows the user to define links to be included, in addition to mandatory links in this example, in a links component 222. A language switching entry 223 allows the user to select whether to include a language-switching component 224. Once the new site request form 200 is completed, the homepage 202 that corresponds to the new site request form 200 can be generated. Only a portion of the components shown in FIG. 2B are discussed above. Other components may be available and may include, for example, a stock price component, a news component, and other links components.

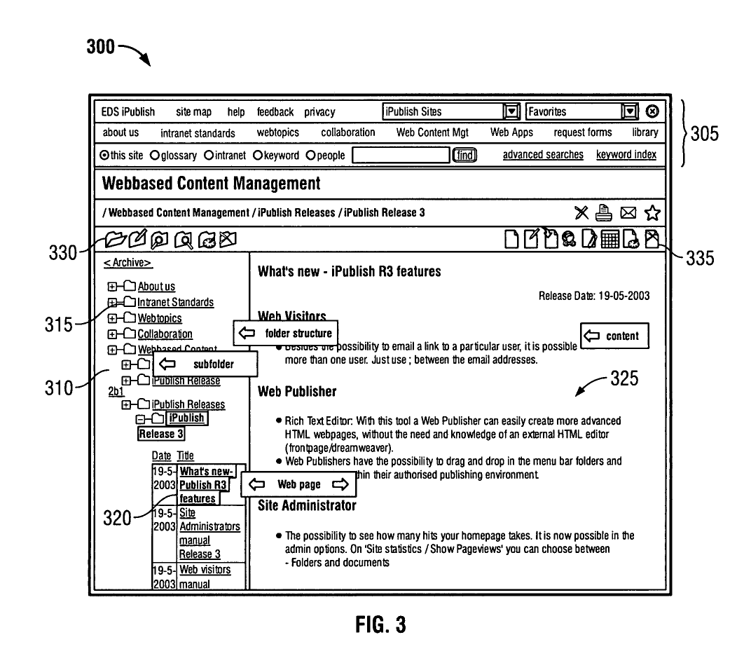

FIG. 3 is an illustrative example of a page 300 for managing web-based content. The web-based content management page 300 illustrates a user interface that may be presented to a content publisher for navigating a folder hierarchy that corresponds to logical structure of the site, for adding and modifying content, and for adding and modifying the folder hierarchy. The web-based content management page 300 may include components 305 that are common to all web pages in the site. The folder hierarchy may be displayed in a folder view 310. The folder hierarchy represents a type of directory for the site and includes folders, one or more levels of sub-folders, and web pages. In this example, the folder view 310 displays folders that correspond to the main information categories in the main information category component 210 of the homepage 202 (see FIG. 2). Each folder can contain sub-folders, web pages, and/or other content elements. For example, the “Intranet Standards” folder 315 may contain an “Intranet Standards” web page that is displayed when a visitor selects the “Intranet Standards” link in the main information category component 210 of the homepage 202. The “Intranet Standards” folder 315 may also contain sub-folders representing subordinate web page links that are displayed in connection with the “Intranet Standards” web page. The sub-folders may contain the subordinate web pages.

In some cases, a folder may contain content elements that represent only a part of a web page. For example, the content of the pull-down menu component 208, the web document links component 214, the calendar component 216, the advertisement component 218, and the online poll component 220 of the homepage 202 (see FIG. 2) may be defined by content elements located in component sub-folders to a homepage folder that corresponds to the homepage 202. Content publication access rights to the homepage folder and the component sub-folders may be granted to the site administrator as a default, or may be assigned to other content publishers.

The folders and the contents thereof are managed by the content publishers that have been given content publication access rights by the site administrator. If a user is granted content publication access rights to a particular web page or group of web pages, the user may be presented with an extra icon on the web page. The extra icon can be used to switch between a browse mode, in which case the user is in the role of a visitor, and a publishing mode, in which case the user is in the role of a content publisher. Content publication access rights may be granted on a folder-by-folder basis or for groups of folders (e.g., a folder and all of the associated subordinate sub-folders). When an authorized content publisher selects a web page 320 within a folder of the folder hierarchy, the web page content 325 is displayed in the user interface.

The web-based content management page 300 includes tools for allowing authorized content publishers to modify content. The authorized content publishers may use folder management tools 330 to add, modify, and delete folders and sub-folders. The folder management tools 330 are represented by icons. By selecting an icon corresponding to a particular folder management tool 330, a content publisher may be able to modify the folder hierarchy. For example, by selecting a create folder icon, the content publisher may be presented with a form for defining a new folder. The content publisher may be able to specify a position of the folder on the form or the position may be determined based on which folder is selected (e.g., highlighted as a result of clicking on the folder with a mouse or other pointing device) when the content publisher selects the create folder icon.

Other folder management tools 330 may allow the content publisher to edit content in a folder, remove a folder, view the access control settings for the folder, and modify other folder settings. For example, the content publisher may be able to select whether and under what conditions the folder hierarchy is displayed for visitors. The content publisher may be able to select whether headlines and corresponding links (e.g., for the most recently added web pages in the folder and the subordinate sub-folders) are displayed on a web page that corresponds to the folder. The content publisher may be able to select whether the folder name and a corresponding link are added to the site map. The content publisher may also drag and drop folders to new locations. The order of sub-folders, web pages, and other content elements within a folder may define the order in which items are displayed.

The site administrator (or content publishers) may also be able to assign access rights for each folder using a folder management tool 330. By selecting a tool for assigning access permissions, the site administrator may be presented with a user interface that allows the site administrator to select, for a currently selected folder, which user group or user groups have visitor access rights and/or content publisher rights and to select user groups for which the web pages contained in the folder will appear on the homepage displayed to the selected user groups.

An authorized content publisher may also use content management tools 335 to add, modify, and delete web pages and other content elements. The folder management tools 335 are represented by icons. By selecting an icon corresponding to a particular content management tool 330, a content publisher may be able to modify the content 325 of a currently displayed web page or add, modify, or delete content to a currently selected folder. For example, by selecting an add document icon, the content publisher may be presented with a form for creating a new web page or other content element. The position of the content may be specified in the form or may be determined based on which folder is selected when the content publisher selects the add document icon.

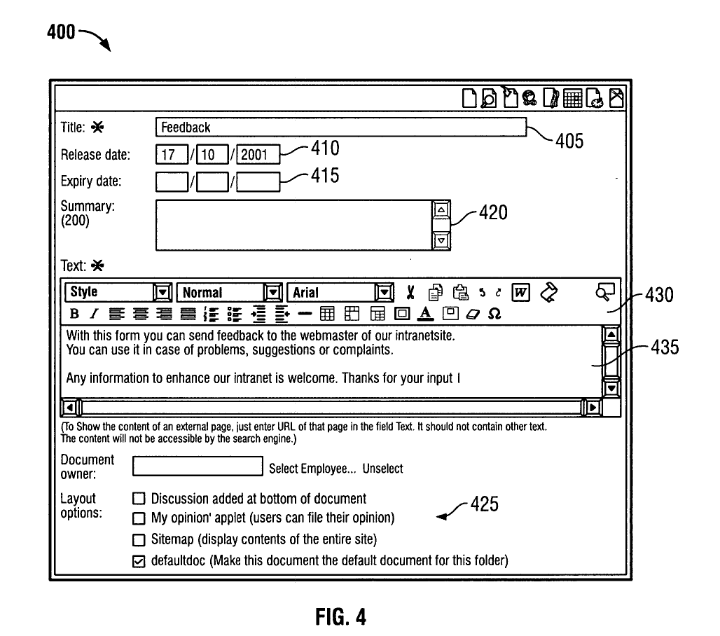

FIG. 4 is an illustrative example of a form 400 for creating new content. The form 400 for creating content includes entry fields for a title 405, a release date 410 (i.e., when the content is to be published), an expiration date 415 (i.e., when the content is to be removed), and a summary 420 to be displayed in the folder hierarchy and in any links to the content. The form may also include selectable layout options 425 for the content, such as whether to add a discussion component (e.g., similar to a discussion forum) to the bottom of a web page, to add a voting box for allowing users to provide ratings, to add a site map to the web page, and designate a web page as a default document to be displayed when the corresponding folder is selected (e.g., if more than one web page is contained in a folder).

The form for creating new content may include a rich text editor 430, which may be in the form of a toolbar, for formatting the text and other features of the content and a content entry field 435 for inserting the text or other content of a web page or other content element. The rich text editor 430 may allow the content publisher to define styles and fonts; cut, copy, and paste; undo and redo; insert icons; link selected text to a particular user in the organizational database; view the HTML code for the content; insert lines, tables, and other graphical features; insert, edit, or remove links; attach images or files; and insert symbols.

Referring again to FIG. 3, other content management tools 335 may allow the content publisher to import a document, web page, or other content into a selected folder; add links into a web page corresponding to a selected folder; add attachments to a folder; remove content elements; and register an event with the calendar for the site.

As discussed above, the web-based content management page 300 illustrates a user interface that may be presented to a content publisher. The web-based content management page 300 corresponds to a page that can be presented to a visitor of the site but contains additional elements. In general, visitors will be presented with the components 305 that are common to all web pages in the site, the content 325, and, in some cases, the folder hierarchy 310. The folder management tools 330 and the content management tools 335 may only be presented to content publishers. Similarly, the folder management tools 330 and the content management tools 335 also may be hidden from content publishers who are not authorized to modify the currently selected folder or folders.

As an alternative to or in addition to using the folder hierarchy for purposes of navigating the site and modifying content, content publishers may navigate the site in accordance with conventional web site navigation techniques. The content management tools 335 may be presented and/or special links may be displayed at the bottom of each web page that allow content publishers to access tools for modifying the content of the web page, adding new subsidiary web pages, and the like. For example, the links component 222 of the homepage 202 (see FIG. 2) may include a special “edit links” link that is only displayed for authorized content publishers and that allows the content publishers to modify the content of the links component 222.

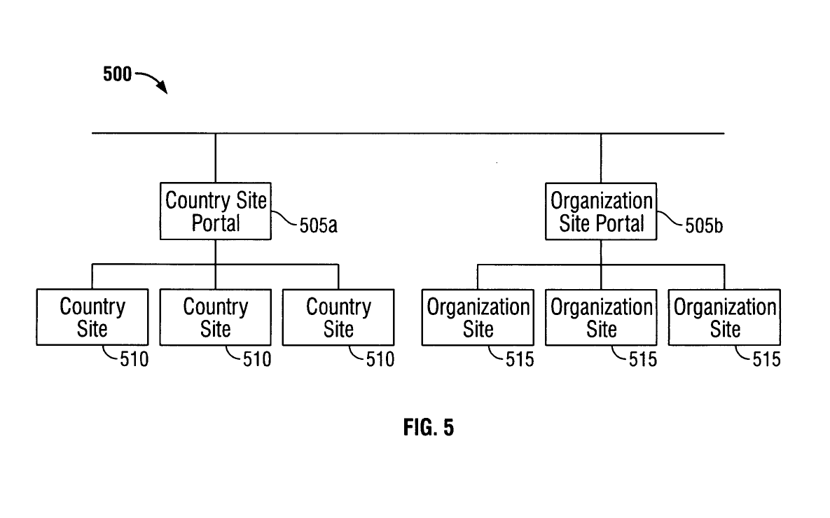

FIG. 5 is a block diagram showing a logical structure 500 for a web environment. The web environment may include multiple portals 505. A first portal 505a may be associated with country sites 510 within an enterprise. The first portal 505a may correspond to a first site generated by the web environment controller 125 (see FIG. 1). The first site may include multiple subsidiary country sites 510, one for each country in which the enterprise operates. Each country site 510 may also be generated by the web environment controller 125. A second portal 505b may be associated with organizational sites. The second portal 505b may correspond to a second site generated by the web environment controller 125. The second site may include multiple subsidiary organization sites 515, one for each organization in the enterprise. The organizations in the enterprise may not correspond to the countries in which the enterprise operates (e.g., the organizations may cross country boundaries). Each organization site 515 may also be generated by the web environment controller 125. The portals 500 may be logically separate but may be supported by the portal 120 (see FIG. 1). Accordingly, the web environment control system 100 may support multiple sites within a hierarchy of sites.

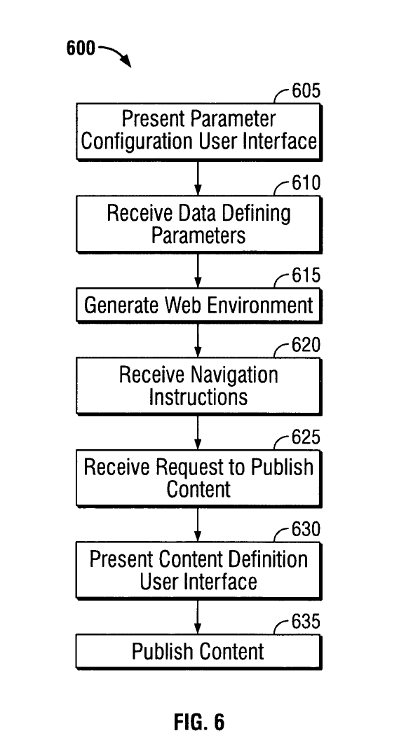

FIG. 6 is a flow diagram of a process 600 for generating a web environment. A user is presented with a user interface that allows the user to configure parameters that relate to a set or library of predefined components that can be enabled or disabled to generate a web environment (step 605). Each predefined component may be a template that defines a presentation format for a portion of a web page. Data defining the parameters for the web environment is received through the user interface (step 610). The parameters define basic components to be included in the web environment. At least a portion of the web environment is generated based on the received data (step 615). The generated web environment includes components specified by the parameters. The components may be arranged in the web environment in accordance with a template that defines a presentation format for the web environment. The generated web environment may include multiple web pages in accordance with the presentation format.

Information relating to a navigation of the web environment to a particular location within the web environment may be received from a content publisher (step 620). A request to publish content at the particular location may be received from the content publisher (step 625). The content publisher may be presented with a user interface for defining content (step 630).

The content may be published for access by visitors to the web environment in accordance with a predefined presentation format (step 635).

The described techniques allow users to generate new sites and publish content with a reduced amount of effort as compared with conventional techniques. For example, users can create sites and publish content without needing to perform difficult HTML or other coding and without requiring complicated formatting procedures. Thus, the techniques provide a simple means for users to create sites and publish content. In addition, users do not have to have detailed knowledge of the logical structure of a site to be able to publish content. Instead, users can easily navigate the site using familiar browsing or folder navigation techniques to select a location where they want to publish content. Furthermore, the definition of content, the presentation format, and the navigation of each site represent separate and distinct tasks. The presentation format is predefined based on templates, and the navigation and content definition are separate tasks in the content publication process.

The techniques also allow the creation of sites that are personalized based on each user's role. The content that is displayed and the portions of the site that are available may be based on each individual user's membership in one or more groups. By using templates that define the presentation format, a consistent look and feel is maintained across all sites and web pages in the overall web environment. Use of a folder hierarchy to define the structure of each site allows users to easily move folders, and thus the corresponding web pages and other content, to different locations within the site. In addition, links are kept up to date. As folders are moved or deleted, links can automatically be updated, which helps reduce the possibility of broken links (i.e., links that point to nonexistent web pages or the former location of a web page).

The described techniques can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The techniques can be performed using one or more programmable processors executing a computer program to perform the described functions by operating on input data and generating output. The techniques can also be performed using special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the techniques, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example, the techniques may be implemented in a system that includes a different number or different type of elements than are depicted in and described in connection with FIG. 1. Accordingly, other implementations are within the scope of the following claims.

1. A method comprising:
presenting a user interface adapted to allow a user to configure parameters relating to a set of predefined components for a web environment;
receiving data defining the parameters for the web environment; and
automatically generating at least a portion of the web environment based on the received data, with the generated web environment including components specified by the parameters.

2. The method of claim 1 wherein the presented user interface comprises a form adapted to allow a user to configure the parameters.

3. The method of claim 2 wherein the form comprises a plurality of entry fields, with each entry field corresponding to one of the predefined components.

4. The method of claim 1 wherein the generated web environment is based on a template defining a presentation format for the generated web environment.

5. The method of claim 4 wherein the parameters include data defining content for the generated web environment.

6. The method of claim 5 wherein the generated web environment comprises a plurality of web pages, the method further comprising:
receiving a request to publish content in at least one of the plurality of web pages;
presenting, in response to the request to publish content, a content definition user interface adapted to receive an identification of content; and
publishing the identified content in accordance with a predefined presentation format.

7. The method of claim 6 further comprising receiving data corresponding to a request to navigate to a particular location within the web environment, wherein the request to publish content is received in connection with a display of the particular location on a user interface and the identified content is published at the particular location.

8. The method of claim 7 wherein the particular location comprises a folder within a folder hierarchy displayed on the user interface, with the folder hierarchy corresponding to a logical structure of the web environment.

9. The method of claim 1 wherein the set of predefined components comprises a library of components that can be enabled, disabled, and customized.

10. The method of claim 1 wherein the predefined components comprise web page components, with each web page component defining a presentation format for data on a web page.

11. The method of claim 10 further comprising:
receiving a request to publish content in at least one of the web page components;
presenting, in response to the request to publish content, a content definition user interface adapted to receive an identification of content; and
publishing the identified content in accordance with a predefined presentation format.

12. The method of claim 11 wherein the content includes at least one link to a web page.

13. The method of claim 12 further comprising:
receiving a request to modify a logical structure of the web environment;
modifying the logical structure of the web environment in accordance with the request to modify the logical structure; and
updating the at least one link in accordance with the modified logical structure.

14. A computer program product, tangibly stored on one or more computer-readable media, for generating a portion of a web environment, comprising instructions operable to cause a programmable processor to:
present a user interface adapted to allow a user to configure parameters relating to a set of predefined components for a web environment;
receive data defining the parameters for the web environment;
receive data defining content associated with at least one of the components; and
automatically generate at least a portion of the web environment based on the received data, with the generated web environment including components specified by the parameters.

15. The computer program product of claim 14 wherein the presented user interface comprises a form adapted to allow a user to configure the parameters.

16. The computer program product of claim 15 wherein the form comprises a plurality of entry fields, with each entry field corresponding to one of the predefined components.

17. The computer program product of claim 14 wherein the generated web environment is based on a template defining a presentation format for the generated web environment.

18. The computer program product of claim 14 wherein the generated web environment comprises a plurality of web pages, the computer program product further comprising instructions operable to cause a programmable processor to:
receive a request to publish content in at least one of the plurality of web pages;
present, in response to the request to publish content, a content definition user interface adapted to receive an identification of content; and
publish the identified content in accordance with a predefined presentation format.

19. The computer program product of claim 18 further comprising instructions operable to cause a programmable processor to receive data corresponding to a request to navigate to a particular location within the web environment, wherein the request to publish content is received in connection with a display of the particular location on a user interface and the identified content is published at the particular location.

20. The computer program product of claim 19 wherein the particular location comprises a folder within a folder hierarchy displayed on the user interface, with the folder hierarchy corresponding to a logical structure of the web environment.

21. The computer program product of claim 14 wherein the set of predefined components comprises a library of components that can be enabled, disabled, and customized.

22. The computer program product of claim 14 wherein the predefined components comprise web page components, with each web page component defining a presentation format for data on a web page.

23. The computer program product of claim 22 further comprising instructions operable to cause a programmable processor to:
receive a request to publish content in at least one of the web page components;
present, in response to the request to publish content, a content definition user interface adapted to receive an identification of content; and
publish the identified content in accordance with a predefined presentation format.

24. The computer program product of claim 23 wherein the content includes at least one link to a web page.

25. The computer program product of claim 24 further comprising instructions operable to cause a programmable processor to:
receive a request to modify a logical structure of the web environment;
modify the logical structure of the web environment in accordance with the request to modify the logical structure; and
update the at least one link in accordance with the modified logical structure.
